(19) United States
(12) Patent Application Publication
(10) Pub. No.: US 2017/0060214 A1
(43) Pub. Date: Mar. 2, 2017

(54) INDICATION SYSTEM AND ELECTRONIC DEVICE UTILIZING THE SAME

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: MENG-LIANG YANG, Shenzhen (CN)

(73) Assignee: HON HAI PRECISION INDUSTRY CO., LTD., New Taipei (TW)

(21) Appl. No.: 14/842,137

(22) Filed: Sep. 1, 2015

(51) Int. Cl. G06F 1/28

(52) U.S. Cl. CPC G06F 1/28

(57) ABSTRACT

An indication system indicates a first power supply unit and a second power supply unit working in a first operation mode or a second operation mode. The indication system includes a power distribution board, a motherboard, and an indication unit. When the motherboard determines that the power supply units are working in the first operation mode, the motherboard outputs a first signal to light a first light-emitting diode of the indication unit. When the motherboard determines that the power supply units are working in the second operation mode, the motherboard outputs a second signal to make a second light-emitting diode of the indication unit flicker.

### FIELD

The subject matter herein generally relates to an electronic device and particular to an indication system used in the electronic device.

### BACKGROUND

Power supply units of a server system usually operate in a 1+1 operation mode or a 2+0 operation mode. In the 1+1 operation mode, two power supply units are connected in parallel, and both output less than half power to the server system. When one of the two power supply units breaks down, the other power supply unit will output more power to ensure the server system continues operating normally. When the server system needs more power, the two power supply units are operated in a 2+0 operation mode. In the 2+0 operation mode, the two power supply units are connected in series, and both output more than half power to the server system. When the two power supply units work in the 2+0 operation mode, if the user unplugs one of the two power supply units, the server system cannot operate normally.

### BRIEF DESCRIPTION OF THE DRAWING

Implementations of the present technology will now be described, by way of example only, with reference to the attached figure.

FIG. 1 is a block diagram of an electronic device with an indication system.

FIG. 2 is a circuit diagram of the indication system of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawing is not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The disclosure will now be described in relation to an electronic device.

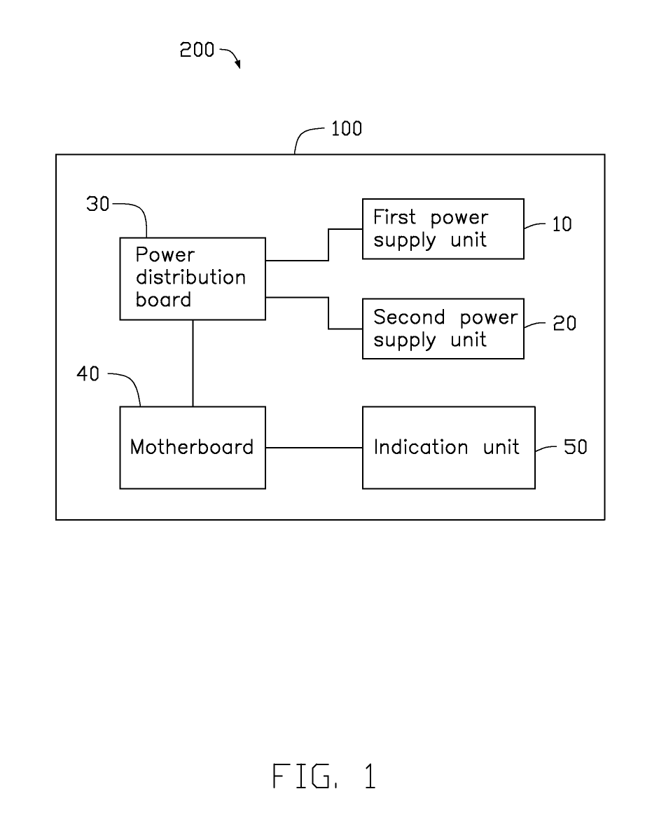

FIG. 1 illustrates a block diagram of an electronic device 200 comprising an indication system 100. The indication system 100 can comprise a first power supply unit 10, a second power supply unit 20, a power distribution board 30, a motherboard 40, and an indication unit 50. The first power supply unit 10 is electrically coupled to the second power supply unit 20 through the power distribution board 30. The power distribution board 30 and the indication unit 50 are electrically coupled to the motherboard 40. In the embodiment, the electronic device 200 can be a server. The indication system 100 indicates that the first power supply unit 10 and the second power supply unit 20 are working in a first operation mode or in a second operation mode.

In at least one embodiment, the first operation mode is a 1+1 operation mode, and a combined output power of the first power supply unit 10 and the second power supply unit 20 is less than half of a combined rated output power of the first power supply unit 10 and the second power supply unit 20. The second operation mode is a 2+0 operation mode, and the combined output power of the first power supply unit 10 and the second power supply unit 20 is more than half of the combined rated output power of the first power supply unit 10 and the second power supply unit 20. For example, if the rated output power of each of the first power supply unit 10 and the second power supply unit 20 is 500 W, the combined output power of the first power supply unit 10 and the second power supply unit 20 is less than 500 W when the first power supply unit 10 and the second power supply unit 20 work in the first operation mode. The combined output power of the first power supply unit 10 and the second power supply unit 20 is more than 500 W when the first power supply unit 10 and the second power supply unit 20 are working in the second operation mode.

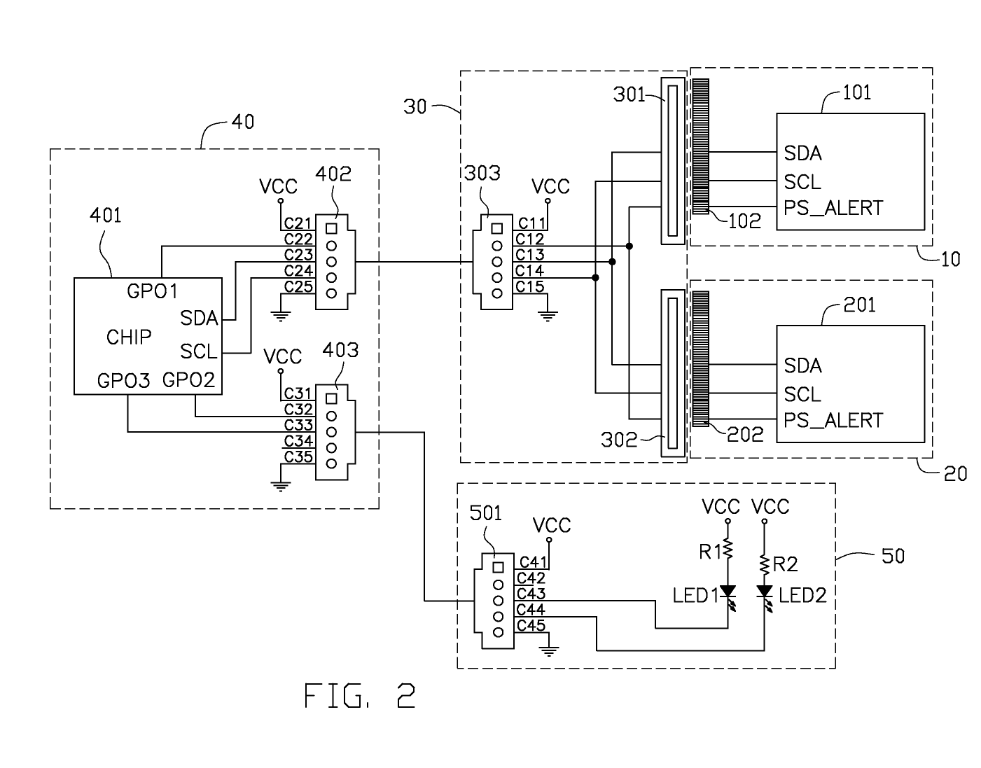

FIG. 2 illustrates a circuit diagram of the indication system 100. The first power supply unit 10 can comprise a first Micro Controller Unit (MCU) 101 and a first edge connector 102. The second power supply unit 20 can comprise a second MCU 201 and a second edge connector 202. Both of the first MCU 101 and the second MCU 201 can comprise a data pin SDA, a clear pin SCL, and an alert pin PS_ALERT. The power distribution board 30 can comprise two slots 301 and 302 and a first connector 303. The motherboard 40 can comprise a chip 401, a second connector 402, and a third connector 403. The indication unit 50 can comprise a fourth connector 501, two light-emitting diodes LED1, LED2, and two resistors R1, R2.

The data pin SDA, the clear pin SCL, and the alert pin PS_ALERT of the first MCU 101 are electrically coupled to the first edge connector 102. The data pin SDA, the clear pin SCL, and the alert pin PS_ALERT of the second MCU 201 are electrically coupled to the second edge connector 202.

The first connector 303 of the power distribution board 30 can comprise connection pins C11, C12, C13, C14, and C15. The connection pin C11 is electrically coupled to a power terminal VCC. The connection pin C15 is grounded. The connection pins C12, C13, and C14 are electrically coupled to the two slots 301 and 302. When the first edge connector 102 and second edge connector 202 are electrically coupled to the two slots 301 and 302 respectively, the first power supply unit 10 is electrically coupled to the second power supply unit 20 through the power distribution board 30. Therefore, the connection pin C12 is electrically coupled to the alert pin PS_ALERT of the first MCU 101 and electrically coupled to the alert pin PS_ALERT of the first MCU 201. The connection pin C13 is electrically coupled to the data pin SDA of the first MCU 101 and electrically coupled to the data pin SDA of the first MCU 201. The connection pin C14 is electrically coupled to the clear pin SCL of the first MCU 101 and electrically coupled to the clear pin SCL of the first MCU 201.

The chip 401 of the motherboard 40 can comprise a data pin SDA, a clear pin SCL, and three general purpose input/output (GPIO) pins GPIO1, GPIO2, and GPIO3. The chip 401 can determine whether the first power supply unit 10 and the second power supply unit 20 are working in the first operation mode or in the second operation mode, according to the combined output power of the first power supply unit 10 and the second power supply unit 20. When the combined output power of the first power supply unit 10 and the second power supply unit 20 is less than half of the combined rated output power of the first power supply unit 10 and the second power supply unit 20, the first power supply unit 10 and the second power supply unit 20 are working in the first operation mode. When the combined output power of the first power supply unit 10 and the second power supply unit 20 is more than half of the combined rated output power of the first power supply unit 10 and the second power supply unit 20, the first power supply unit 10 and the second power supply unit 20 are working in the second operation mode. When the chip 401 determines that the first power supply unit 10 and the second power supply unit 20 are working in the first operation mode, the GPIO pin GPIO2 of the chip 401 outputs a first signal to the third connector 403. When the chip 401 determines that the first power supply unit 10 and the second power supply unit 20 are working in the second operation mode, the GPIO pin GPIO3 of the chip 401 outputs a second signal to the third connector 403.

The chip 401 further determines whether the first power supply unit 10 and the second power supply unit 20 are working in a warning mode, according to warning signals output by the first power supply unit 10 and the second power supply unit 20. When the chip 401 determines that the first power supply unit 10 and the second power supply unit 20 are working in the warning mode, the GPIO pin GPIO3 of the chip 401 outputs a third signal to the third connector 403.

The second connector 402 of the motherboard 40 can comprise connection pins C21, C22, C23, C24, and C25. The connection pin C21 is electrically coupled to the power terminal VCC. The connection pin C22 is electrically coupled to the GPIO pin GPIO1 of the chip 401. The connection pin C23 is electrically coupled to the data pin SDA of the chip 401. The connection pin C24 is electrically coupled to the clear pin SCL of the chip 401. The connection pin C25 is grounded. The second connector 402 of the motherboard 40 is electrically coupled to the first connector 303 of the power distribution board 30 through an inter integrated circuit (I2C) cable.

The third connector 403 of the motherboard 40 can comprise connection pins C31, C32, C33, C34, and C35. The connection pin C31 is electrically coupled to the power terminal VCC. The connection pin C32 is electrically coupled to the GPIO pin GPIO2 of the chip 401. The connection pin C33 is electrically coupled to the GPIO pin GPIO3 of the chip 401. The connection pin C35 is grounded.

The fourth connector 501 of the indication unit 50 can comprise connection pins C41, C42, C43, C44, and C45. The connection pin C41 is electrically coupled to the power terminal VCC. The connection pin C42 is electrically coupled to a cathode of the light-emitting diode LED1, and an anode of the light-emitting diode LED1 is electrically coupled to the power terminal VCC through the resistor R1. The connection pin C43 is electrically coupled to a cathode of the light-emitting diode LED2, and an anode of the light-emitting diode LED2 is electrically coupled to the power terminal VCC through the resistor R2. The connection pin C45 is grounded. The fourth connector 501 of the indication unit 50 is electrically coupled to the third connector 403 of the motherboard 40 through an I2C cable. In at least one embodiment, the light-emitting diodes LED1 emits green light when illuminated, and the light-emitting diodes LED2 emits red light when illuminated.

In use, when the first power supply unit 10 is electrically coupled to the second power supply unit 20 through the power distribution board 30, the chip 401 of the main board 40 can determine whether the first power supply unit 10 and the second power supply unit 20 are working in the first operation mode or in the second operation mode through the I2C cable. When the chip 401 determines that the first power supply unit 10 and the second power supply unit 20 are working in the first operation mode, the GPIO pin GPIO2 of the chip 401 outputs the first signal to the connection pin C42 of the fourth connector 501 through the I2C cable, the connection pin C42 of the fourth connector 501 outputs the first signal to light the light-emitting diode LED1. In at least one embodiment, the light-emitting diodes LED1 emits green light when illuminated. Therefore, in the first operation mode, the light-emitting diodes LED1 emits green light, to indicate that the first power supply unit 10 and the second power supply unit 20 are working in the first operation mode.

When the chip 401 determines that the first power supply unit 10 and the second power supply unit 20 are working in the second operation mode, the GPIO pin GPIO3 of the chip 401 outputs the second signal to the connection pin C43 of the fourth connector 501 through the I2C cable, the connection pin C43 of the fourth connector 501 outputs the second signal to make the light-emitting diode LED2 flicker. In at least one embodiment, the light-emitting diodes LED2 emits red light when illuminated. Therefore, in the second operation mode, the light-emitting diodes LED2 flickers red light, to indicate that the first power supply unit 10 and the second power supply unit 20 are working in the second operation mode.

When the chip 401 determines that the first power supply unit 10 and the second power supply unit 20 are working in the warning mode, the GPIO pin GPIO3 of the chip 401 outputs the third signal to the connection pin C43 of the fourth connector 501 through the I2C cable, the connection pin C43 of the fourth connector 501 outputs the third signal to light the light-emitting diode LED2. In at least one embodiment, the light-emitting diodes LED1 emits red light when illuminated. Therefore, in the warning mode, the light-emitting diodes LED2 emits red light, to indicate that the first power supply unit 10 and the second power supply unit 20 are working in the warning mode.

The embodiments shown and described above are only examples. Even though numerous characteristics and advantages of the present technology have been set forth in the foregoing description, together with details of the structure and function of the present disclosure, the disclosure is illustrative only, and changes may be made in the details, including matters of shape, size, and arrangement of the parts within the principles of the present disclosure, up to and including the full extent established by the broad general meaning of the terms used in the claims.

What is claimed is:

1. An indication system configured to indicate a first power supply unit and a second power supply unit working in a first operation mode or a second operation mode, the indication system comprising:
a power distribution board electrically coupled to the first power supply unit and the second power supply unit;
a motherboard electrically coupled to the power distribution board and is configured, in event that the motherboard determines that the first power supply unit and the second power supply unit are working in the first operation mode, to output a first signal to light a first light-emitting diode of the indication unit; and
an indication unit electrically coupled to the motherboard;
wherein the motherboard is configured, in event that the motherboard determines that the first power supply unit and the second power supply unit are working in the second operation mode, to output a second signal to make a second light-emitting diode of the indication unit flicker.

2. The indication system of claim 1, wherein the motherboard comprises a chip, a second connector, and a third connector; wherein the chip comprises a first GPIO pin, a second GPIO pin, and a third GPIO pin; an anode of the first light-emitting diode is electrically coupled to a power terminal, a cathode of the first light-emitting diode is electrically coupled to the second GPIO pin through an inter integrated circuit (I2C) cable, an anode of the second light-emitting diode is electrically coupled to the power terminal, a cathode of the second light-emitting diode is electrically coupled to the third GPIO pin through the inter integrated circuit (I2C) cable;
wherein the chip of the motherboard is configured such that in event that the chip determines that the first power supply unit and the second power supply unit are working in the first operation mode, the second GPIO pin of the chip outputs the first signal to light the first light-emitting diode;
wherein the chip of the motherboard is further configured such that in event that the chip determines that the first power supply unit and the second power supply unit are working in the second operation mode, the third GPIO pin of the chip outputs the second signal to make the second light-emitting diode flicker.

3. The indication system of claim 2, wherein the chip of the motherboard is further configured such that in event that the chip determines that the first power supply unit and the second power supply unit are working in a warning mode, the third GPIO pin of the chip outputs a third signal to light the second light-emitting diode.

4. The indication system of claim 2, wherein the chip of the motherboard determines that the first power supply unit and the second power supply unit are working in the first operation mode, when a combined output power of the first power supply unit and the second power supply unit is less than half of the combined rated output power of the first power supply unit 10 and the second power supply unit.

5. The indication system of claim 4, wherein the chip of the motherboard determines that the first power supply unit and the second power supply unit are working in the second operation mode, when the combined output power of the first power supply unit and the second power supply unit is more than half of the combined rated output power of the first power supply unit and the second power supply unit.

6. The indication system of claim 5, wherein the first light-emitting diode emits green light when illuminated; and the second light-emitting diode emits red light when illuminated.

7. The indication system of claim 2, wherein the power distribution board comprises a first connector electrically coupled to the second connector of the motherboard through the inter integrated circuit (I2C) cable.

8. The indication system of claim 7, wherein the indication unit comprises a fourth connector electrically coupled to the third connector of the motherboard through the inter integrated circuit (I2C) cable.

9. An electronic device comprising an indication system, the indication system comprising:
a first power supply unit;
a power distribution board;
a second power supply unit electrically coupled to the first power supply unit through the power distribution board;
a motherboard electrically coupled to the power distribution board and is configured, in event that the motherboard determines that the first power supply unit and the second power supply unit are working in the first operation mode, to output a first signal to light a first light-emitting diode of the indication unit; and
an indication unit electrically coupled to the motherboard;
wherein the motherboard is configured, in event that the motherboard determines that the first power supply unit and the second power supply unit are working in the second operation mode, to output a second signal to make a second light-emitting diode of the indication unit flicker.

10. The electronic device of claim 9, wherein the motherboard comprises a chip, a second connector, and a third connector; wherein the chip comprises a first GPIO pin, a second GPIO pin, and a third GPIO pin; an anode of the first light-emitting diode is electrically coupled to a power terminal, a cathode of the first light-emitting diode is electrically coupled to the second GPIO pin through an inter integrated circuit (I2C) cable, an anode of the second light-emitting diode is electrically coupled to the power terminal, a cathode of the second light-emitting diode is electrically coupled to the third GPIO pin through the inter integrated circuit (I2C) cable;
wherein the chip of the motherboard is configured such that in event that the chip determines that the first power supply unit and the second power supply unit are working in the first operation mode, the second GPIO pin of the chip outputs the first signal to light the first light-emitting diode;
wherein the chip of the motherboard is further configured such that in event that the chip determines that the first power supply unit and the second power supply unit are working in the second operation mode, the third GPIO pin of the chip outputs the second signal to make the second light-emitting diode flicker.

11. The electronic device of claim 10, wherein the chip of the motherboard is further configured such that in event that the chip determines that the first power supply unit and the second power supply unit are working in a warning mode, the third GPIO pin of the chip outputs a third signal to light the second light-emitting diode.

12. The electronic device of claim 10, wherein the chip of the motherboard determines that the first power supply unit and the second power supply unit are working in the first operation mode, when a combined output power of the first power supply unit and the second power supply unit is less than half of the combined rated output power of the first power supply unit and the second power supply unit.

13. The electronic device of claim 12, wherein the chip of the motherboard determines that the first power supply unit and the second power supply unit are working in the second operation mode, when the combined output power of the first power supply unit and the second power supply unit is more than half of the combined rated output power of the first power supply unit and the second power supply unit.

14. The electronic device of claim 13, wherein the first light-emitting diode emits green light when illuminated; and the second light-emitting diode emits red light when illuminated.

15. The electronic device of claim 10, wherein the power distribution board comprises a first connector electrically coupled to the second connector of the motherboard through the inter integrated circuit (I2C) cable.

16. The electronic device of claim 15, wherein the indication unit comprises a fourth connector electrically coupled to the third connector of the motherboard through the inter integrated circuit (I2C) cable.
